(19) United States
(12) Patent Application Publication
(10) Pub. No.: US 2016/0332195 A1
(43) Pub. Date: Nov. 17, 2016

(54) WOOD LACQUER COATING METHOD

(71) Applicants: Fu-Xiang LI, Beijing (CN); Wei JIANG, Corona, CA (US)

(72) Inventors: Fu-Xiang LI, Beijing (CN); Hong-Bing TSAI, Yilan (TW)

(21) Appl. No.: 14/708,773

(22) Filed: May 11, 2015

(51) Int. Cl. B05D 7/08; B05D 7/00

(52) U.S. Cl. CPC B05D 7/08; B05D 7/5883

(57) ABSTRACT

A wood lacquer coating method is disclosed. The disclosed method includes applying aqueous white primer consisting of certain components to a wood substrate, applying aqueous varnish consisting of certain components to the aqueous white primer coated on the wood substrate, and applying aqueous color finish consisting of certain components to the wood substrate coated by the aqueous white primer and the aqueous varnish on the aqueous white primer.

### BACKGROUND

1. Technical Field

The present disclosure relates to a wood lacquer coating method, in particular, to a wood lacquer coating method allowing for wood lacquer to dry in a relatively quick fashion.

2. Description of Related Art

A conventional pencil manufacturing process includes steps of: preparing the pencil lead and the pen main body, placing the pencil lead into a corresponding trench, shaping the pencil main body and applying the white primer to the main body for around nine times. That applying the white primer to the main body for nine times is because the pencil main body, which is made of the wood, defines wood grain. In order for the pencil to be in possession of smooth touch, repeating the application of the white primer for nine times becomes necessary.

However, as the conventional aqueous white primer typically takes a long period of time to be fully dried after being applied to the object, the time for the manufacturing of the pencil to conclude would be prolonged, dramatically reducing efficiency of the manufacturing.

### SUMMARY OF THE DISCLOSURE

To overcome the above-mentioned problem, the present disclosure is to provide a wood lacquer coating method. The disclosed method includes applying aqueous white primer to a wood substrate, applying aqueous varnish to the aqueous white primer coated on the wood substrate, and applying aqueous color finish to the wood substrate coated by the aqueous white primer and the aqueous varnish on the aqueous white primer.

The aqueous white primer in one embodiment is formed by poly-acrylic acid emulsion 20-70% in weight percentage, poly-urethane emulsion 5-50% in weight percentage, kaolin 3-20% in weight percentage, an anti-foaming agent 0.1-2.2% in weight percentage, a thickening agent 0.1-2.0% in weight percentage, coalescent 0.5-10% in weight percentage, carbonate calcium up to 25% in weight percentage, and titanium dioxide powder 2-25% in weight percentage;

The aqueous varnish is in one embodiment formed by the poly-acrylic acid emulsion 30-92% in weight percentage, the poly-urethane emulsion 5-60% in weight percentage, the anti-foaming agent 0.1-2.2% in weight percentage, the thickening agent 0.1-2.0% in weight percentage, and the coalescent 0.5-10% in weight percentage; and

The aqueous color finish in one embodiment is formed by the poly-acrylic acid emulsion 20-80% in weight percentage, the poly-urethane emulsion 10-60% in weight percentage, the kaolin 3-25% in weight percentage, the anti-foaming agent 0.1-2.2% in weight percentage, the thickening agent 0.1-2.0% in weight percentage, the coalescent 0.5-10% in weight percentage, the calcium carbonate 1-20% in weight percentage, and toner 2-40% in weight percentage.

In one embodiment, the poly-acrylic emulsion is Rohm-Haas PL-51.

In one embodiment, the poly-urethane emulsion is APU-66.

In one embodiment, the anti-foaming agent is BYK®-019.

In one embodiment, the thickening agent is Aquaflow™ NHS-300.

In one embodiment, the coalescent is 2,2,4-trimethyl-1,3-pentanediol monoisobutyrate.

In another embodiment, the coalescent is Texanol™ ester alcohol-12.

For further understanding of the present disclosure, reference is made to the following detailed description illustrating the embodiments and examples of the present disclosure. The description is only for illustrating the present disclosure, not for limiting the scope of the claim.

### BRIEF DESCRIPTION OF THE DRAWINGS

[No corresponding figures in this application]

### DESCRIPTION OF THE EXEMPLARY EMBODIMENTS

The aforementioned and other technical contents, features, and efficacies will be shown in the following detail descriptions of a preferred embodiment corresponding with the reference Figures.

### Embodiment 1: Preparation of Aqueous White Primer

The aqueous white primer may be prepared by the mix of: poly-acrylic acid emulsion 20-70% in weight percentage, poly-urethane emulsion 5-50% in weight percentage, kaolin 3-20% in weight percentage, an anti-forming agent 0.1-2.2% in weight percentage, a thickening agent 0.1-2.0% in weight percentage, coalescent 0.5-10% in weight percentage, calcium carbonate up to 25% in weight percentage, and titanium dioxide powder 2-25% in weight percentage. The above components may be sequentially inputted into a container equipped a stirring device to have them uniformly stirred in order to prepare the aqueous white primer.

As shown in Table 1, the aqueous white primer prepared as set forth above may be smooth in appearance, superior in coverage, and with viscosity more than 60 seconds. Further, the time for the surface of such aqueous white primer to dry may be one minute though the time for the entire primer to dry may be five hours. Impact resistance of such aqueous white primer may be 60 kilograms per square foot, water resistance of the same may be 72 hours without change while the aqueous white primer may be subject to no change to lacquer film after going through 60% ethanol in alcohol resistance test, and heat-resistance test.

### Embodiment 2: Preparation of Aqueous Varnish

The aqueous varnish may be prepared by the mix of the poly-acrylic acid emulsion 30-92% in weight percentage, the poly-urethane emulsion 5-60% in weight percentage, the anti-foaming agent 0.1-2.2% in weight percentage, the thickening agent 0.1-2.0% in weight percentage, and the coalescent 0.5-10% in weight percentage. The aqueous varnish may be prepared with the above-mentioned components and their respective ratios with the components placed into the container having the stirring device, for having the mix of them uniformly stirred.

Also shown in Table 1, the prepared aqueous varnish may be smooth in appearance, superior in coverage, and with viscosity more than 45 seconds. Further, the time for the surface of such aqueous varnish to dry may be 40 seconds though the time for the entire varnish to dry may be three hours. Impact resistance of such aqueous varnish may be 60 kilograms per square foot, water resistance of the same may be 72 hours without change while the aqueous varnish may be subject to no change to lacquer film after going through 60% ethanol in alcohol resistance test, and heat-resistance test.

### Embodiment 3: Preparation of Aqueous Color Finish

The aqueous color finish may be prepared by the mix of the poly-acrylic acid emulsion 20-80% in weight percentage, the poly-urethane emulsion 10-60% in weight percentage, the kaolin 3-25% in weight percentage, the anti-foaming agent 0.1-2.2% in weight percentage, the thickening agent 0.1-2.0% in weight percentage, the coalescent 0.5-10% in weight percentage, the calcium carbonate 1-20% in weight percentage, and toner 2-40% in weight percentage.

Also suggested in Table 1, such aqueous color finish may be: smooth in appearance, bright in color, superior in coverage, and with viscosity more than 60 seconds. Further, the time for the surface of such color finish to dry may be 50 seconds though the time for the entire color finish to dry may be 3.5 hours. Impact resistance of such color finish may be 60 kilograms per square foot, water resistance of the same may be 72 hours without change while the aqueous color finish may be subject to no change to lacquer film after going through 60% ethanol in alcohol resistance test, and heat-resistance test.

Conventional embodiment: recipe of traditional aqueous poly-acrylic acid emulsion:
aqueous acrylic resin: 37-69% in weight percentage, which is typical emulsion, to form films,
ethanol: 10-20% in weight percentage for diluting and fast drying,
purified water: 5-10% in weight percentage for stabilization and dilution,
curing agent: 50% in weight percentage for film solidification,
moisturizing agent: 0-0.2% in weight percentage for moisturizing the substrate;
dispersant: up to 0.3% in weight percentage for resin dispersion,
anti-foaming agent: up to 0.2% in weight percentage for eliminating bubbles generated in the manufacturing,
Zinc stearate: up to 2% in weight percentage to cause the smoothing effect at the film,
leveling agent: up to 0.5% in weight percentage to cause the leveling effect at the film, and
alcohol esters-12: up to 2% in weight percentage to enhance the forming of the film.

The above components are placed in the corresponding container with the stirring device sequentially so as to result in the traditional aqueous paint or lacquer.

Also indicated in Table 1, such aqueous lacquer using the primary components such as the aqueous poly-acrylic acid emulsion, the ethanol, the purified water and the curing agent could be in the possession of lack of mechanical impurities, being smooth in film appearance, viscosity more than 35 seconds. Further, the time for the surface of such aqueous lacquer to dry may be 30 minutes though the time for the entire lacquer to dry may be 12 hours. Impact resistance of such aqueous lacquer may be 50 kilograms per square foot, water resistance of the same may be 72 hours without change while the aqueous lacquer may be subject to no change to lacquer film after going through 60% ethanol in alcohol resistance test, and heat-resistance test.

TABLE 1

| | | | | Traditional |
|---|---|---|---|---|
| | Aqueous | Aqueous | Aqueous | aqueous |
| | white primer | varnish | color finish | lacquer |
| | (embodiment | (embodiment | (embodiment | (comparative |
| | 1) | 2) | 3) | example) |
| Apperance | smooth | Smooth | smooth | smooth |
| Coverage | good | Good | good | good |
| Viscosity | >60 seconds | >45 seconds | >60 seconds | >35 seconds |
| Time for | 1 minute | 40 seconds | 50 seconds | 30 minutes |
| surface to dry | | | | |
| Time for | 5 hours | 3 hours | 3.5 hours | 12 hours |
| entire | | | | |
| structure to | | | | |
| dry | | | | |
| Impact | 60 kg/m² | 60 kg/m² | 60 kg/m² | 50 kg/m² |
| resistance | | | | |
| Water | No change in | No change in | No change in | No change in |
| resistance | 72 hours | 72 hours | 72 hours | 72 hours |
| Alcohol | No change to | No change to | No change to | No change to |
| resistance | film with | film with | film with | film with |
| | 60% alcohol | 60% alcohol | 60% alcohol | 60% alcohol |
| Heat | No change to | No change to | No change to | No change to |
| resistance | film | film | film | film |

Therefore, it could be seen that the aqueous white primer, the aqueous varnish, and the aqueous color finish according to the present disclosure are associated with shortened time for the surface to dry and shortened time for the whole structure to dry, when compared to the traditional aqueous lacquer. When multi-layered coating becomes necessary, such aqueous white primer, aqueous varnish, and aqueous color finish could save extra time for the corresponding tasks to be accomplished because of the shortened time to dry. Plus, film coating using the present disclosure is stable and uniform in quality, enhancing the manufacturing efficiency.

Some modifications of these examples, as well as other possibilities will, on reading or having read this description, or having comprehended these examples, will occur to those skilled in the art. Such modifications and variations are comprehended within this disclosure as described here and claimed below. The description above illustrates only a relative few specific embodiments and examples of the present disclosure. The present disclosure, indeed, does include various modifications and variations made to the structures and operations described herein, which still fall within the scope of the present disclosure as defined in the following claims.

What is claimed is:

1. A wood lacquer coating method, comprising:
applying aqueous white primer to a wood substrate, wherein the aqueous white primer is formed by poly-acrylic acid emulsion 20-70% in weight percentage, poly-urethane emulsion 5-50% in weight percentage, kaolin 3-20% in weight percentage, an anti-foaming agent 0.1-2.2% in weight percentage, a thickening agent 0.1-2.0% in weight percentage, coalescent 0.5-10% in weight percentage, carbonate calcium up to 25% in weight percentage, and titanium dioxide powder 2-25% in weight percentage;
applying aqueous varnish to the aqueous white primer coated on the wood substrate, wherein the aqueous varnish is formed by the poly-acrylic acid emulsion 30-92% in weight percentage, the poly-urethane emulsion 5-60% in weight percentage, the anti-foaming agent 0.1-2.2% in weight percentage, the thickening agent 0.1-2.0% in weight percentage, and the coalescent 0.5-10% in weight percentage; and
applying aqueous color finish to the wood substrate coated by the aqueous white primer and the aqueous varnish on the aqueous white primer, wherein the aqueous color finish is formed by the poly-acrylic acid emulsion 20-80% in weight percentage, the poly-urethane emulsion 10-60% in weight percentage, the kaolin 3-25% in weight percentage, the anti-foaming agent 0.1-2.2% in weight percentage, the thickening agent 0.1-2.0% in weight percentage, the coalescent 0.5-10% in weight percentage, the calcium carbonate 1-20% in weight percentage, and toner 2-40% in weight percentage.

2. The method according to claim 1, wherein the poly-acrylic emulsion is Rohm-Haas PL-51.

3. The method according to claim 1, wherein the poly-urethane emulsion is APU-66.

4. The method according to claim 1, wherein the anti-foaming agent is BYK®-019.

5. The method according to claim 1, wherein the thickening agent is Aquaflow™ NHS-300.

6. The method according to claim 1, wherein the coalescent is 2,2,4-trimethyl-1,3-pentanediol monoisobutyrate.

7. The method according to claim 6, wherein the coalescent is Texanol™ ester alcohol-12.
